(19) United States
(12) Patent Application Publication
(10) Pub. No.: US 2004/0164195 A1
(43) Pub. Date: Aug. 26, 2004

(54) Rotor tip

(76) Inventor: Angus Peter Robson, Matamata, NZ (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/476,651

(22) PCT Filed: May 6, 2002
(86) PCT No.: PCT/NZ02/00087

(30) Foreign Application Priority Data
May 6, 2001 (NZ) 511181

(51) Int. Cl. B02C 19/00

(52) U.S. Cl. 241/275

(57) ABSTRACT

The present invention relates to a method of assembling a rotor for use in a rock crusher characterised by the step of positioning a resilient material between a rotor tip holder and the rotor.

### TECHNICAL FIELD

This invention relates to improvements to rotor tips.

Reference throughout the specification should be made to the use of the present invention for the improvements to rotor tips in centrifugal rock crushers.

### BACKGROUND ART

Centrifugal rock crushers operate by having a spinning rotor into which rock of predetermined size range is gravity fed. Within the rotor are a number of blades (typically three) positioned close to apertures in the outer perimeter of the rotor.

As the rotor rotates, rock builds up on the blades within the rotor before being eventually flung out of the aperture into a crushing chamber. The impact of the rocks on each other or on anvils causes the rocks to break down to a desired size.

One of the problems associated with typical centrifugal crushers is that there is considerable wear and tear on the exit apertures of the rotor. In order to address this problem rotors have hard wearing rotor tips and tip holders positioned at the trailing edge of the apertures. Typically these rotor tip holders comprise of a mounting portion by which the tip holder is attached to the rotor and a raised portion which contains a rotor tip in the form of a tungsten insert. The configuration and positioning of the tip is such that rocks exiting the rotor through the apertures impact upon the tungsten rather than on the more readily damaged parts of the rotor.

Unfortunately, tungsten tips wear down along with the tip holders and these have to be replaced at regular intervals. Tungsten is an expensive material and therefore it is desirable if the tip could be replaced less often. Further, the downtime in the operation of the rock crusher during changeover of tip holders is also an expensive exercise.

One of the reasons that the tips break down is that they tend to fracture due to shock loading. Sometimes the tungsten tips are required to be brazed into the tip holder. This process can impart thermal shock to the tungsten, making it more susceptible to shock loading during the operation of the rock crusher.

With present systems the size of rock is dependent upon the impact force it imparts on the rotor tip as heavier rocks can cause the tip to wear out too quickly. It would also be desirable to increase the size/mass of the rock fed into the rotor.

One reason that it is desirable to have a larger sized rock feed is that an increase in size means that less primary crushing is required prior to the introduction of the rock into the centrifugal crusher. Further, smaller rock is harder to break or split in the crusher than larger rock due to reduced inertia. Finally, the greater the mass of the rock, the larger the impact when the rock hits the rock bed after exiting the rotor, which again leads to greater crushing power.

Another factor contributing to the wear and tear on the rotor tip is the direct exposure it has to rock exiting the rotor. It would be desirable that there could be some way that the rock wave which builds up on the blades could somehow offer some protection to the tip.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a method of assembling a rotor for use in a rock crusher characterised by the step of

a) positioning a resilient material between a rotor tip holder and the rotor

According to another aspect of the present invention there is provided a resilient material adapted for use in a rotor for a rock crusher

the material characterised in that

the material is configured to fit between a rotor tip holder and the rotor.

The present invention also includes a rotor configured to include resilient material as described as well as a rock crusher incorporating a rotor as described.

The term resilient material means any material which is capable of receiving an impact or deformation and then returning to substantially the same shape prior to the impact.

The resilient material may come in a variety of forms.

In one embodiment, the resilient material is in the form of two strips of 10 mm thick polyurethane placed between the bearing surfaces of the tip holder and the rotor. The inventor has found that polyurethane having a Shore hardness of 95 on the C scale is particularly suitable.

It should be appreciated however that this is given by way of example only and polyurethane with different properties and dimensions may be used as well as other types of material, for example hard rubber.

In some embodiments of the present invention a combination of materials may be used to give the required resilience. For example, some materials may deform over time and lose memory. Restraining these materials during impact however would remove their resilience or elasticity. Thus, there may be provided for example additional resilient or hardening substance that can give extra support to the base resilient material.

In one embodiment, there may be provided resilient material in the form of polyurethane reinforced with steel shims. In one embodiment there may be a shim or shims sandwiched between blocks of polyurethane.

It should be appreciated that material other than steel may be used, for example carbon fibre.

In alternate embodiment of the present invention there may be imbedded within the polyurethane a biasing means. In one embodiment this may be in the form of a leaf spring. After the spring is depressed during a rock impact, the spring may assist the polyurethane to return to its original shape through release of the stored energy within the spring.

The applicant has found that the present invention gives considerable advantages and vastly increases the life of the rotor tip in both high impact and general abrasive wear situations.

An example of this is illustrated below.

The applicant tested a conventional system alongside the present invention with varying size impacts until fracture or destruction of the rotor tip occurred.

In the conventional situation the rotor tip and holder was bolted directly to a metal sheet in a similar manner that it is bolted onto a conventional rotor. A weight was dropped from a standard height (800 mm) five times onto the rotor tip. After the fifth time if the tip had not fractured, a further 2 kgs was added to the weight.

The same procedure was applied (from a height of 1400 mm) to a rotor tip and holder which had a 10 mm sheet of polyurethane (SHD95C) between the tip holder and the base surface. This tip holder was preloaded to that expected from centrifugal force at normal operating speed.

The conditions at which each tip fractured (received a terminal blow) are given in the table below.

| | | | TERMINAL |
|---|---|---|---|
| | DROP | WEIGHT | BLOW |
| CONVENTIONAL | 800 mm | 16 kgs | 3 |
| SYSTEM | | | |
| PRESENT | 1400 mm | 22 kgs | 4 |
| INVENTION | | | |

It can be seen that the present invention enables rotor tips to last longer before fracturing and to take greater impacts. This has a number of advantages over the prior art.

There is less downtime in the operation of the rotor as the rotor tips do not have to be changed as often. This is also less expensive having regard to the cost of replacement of a rotor tip.

Another advantage of the present invention is that a greater feed size of rocks can be introduced into the rotor as the effective impact on the rotor tip is less due to the cushioning layer. This increase in rock feed means less primary crushing, the rock is easier to break and there is subsequently greater impact on the rock bed leading to greater crushing efficiency.

Further as the rotor tips can take greater impacts, the rotor can turn faster leading to a greater angular acceleration and thus a greater impact force of rock exiting the rotor and hitting the rock bed.

Another advantage of the present invention is that it appears to allow creep of the rock wave on the blades towards the rotor tip. This means that the rock layer can actually protect the tip to a degree also cushioning the tip from direct impacts. In conventional systems fines pack into the rocks forming the rock layer which tends to hold the rocks together. It is believed that the present invention allows some vibration as result of the resilient material which prevents the fines from packing and enables the rock wave to creep accordingly.

It is an object of the present invention to address the foregoing problems or at least to provide the public with a useful choice.

### BRIEF DESCRIPTION OF DRAWINGS

Further aspects of the present invention will become apparent from the ensuing description which is given by way of example only and with reference to the accompanying drawings in which:

FIG. 1 is a diagrammatic plan view of a rotor, and

FIG. 2 is a diagrammatic view illustrating the bearing surfaces of a rotor tip in relation to the rotor, and

FIG. 3 illustrates one possible form of a resilient material in accordance with the present invention, and

FIG. 4 illustrates an alternate form of resilient material in accordance with the present invention.

### BEST MODES FOR CARRYING OUT THE INVENTION

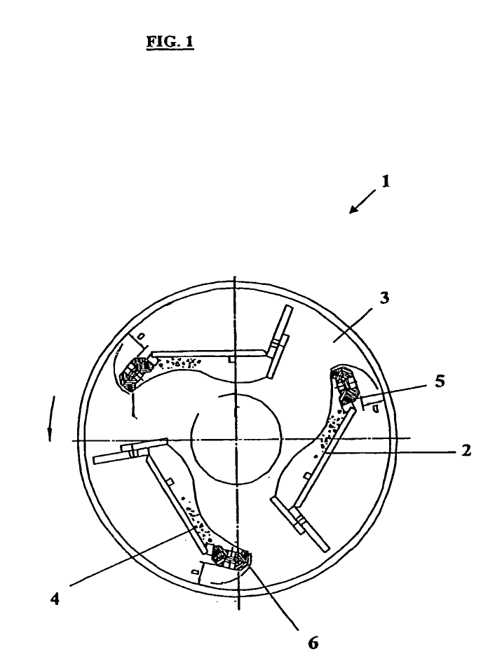

With respect to FIG. 1 there is illustrated a rotor generally indicated by arrow 1.

The rotor (1) has three blades (2) which are positioned just prior to exit apertures (3) of the rotor (1).

When the rotor (1) is rotating in the direction of the arrow shown, rock (4) builds up in waves on the blades (2).

Positioned next to the blades (2) and before the trailing edge of the aperture (3) is a tip holder (5) which is mounted to the inner wall of the rotor (1). The tip holder (5) holds a tungsten tip (6) (not clearly shown).

It can be seen from the configuration shown in FIG. 1 that rock exiting the rotor (1) passes over the tip (6).

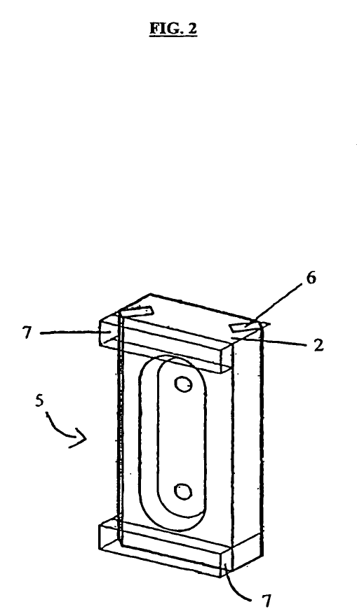

Referring now to FIG. 2, sandwiched between the tip holder (5) and the rotor wall or the rotor (1) is a resilient material (7). In this embodiment the resilient material is 10 mm polyurethane having a hardness of SHD95C.

It can be seen that there are only two bearing surfaces between the tip holder (5) and the rotor (1). These are separated from each other by the resilient material (7).

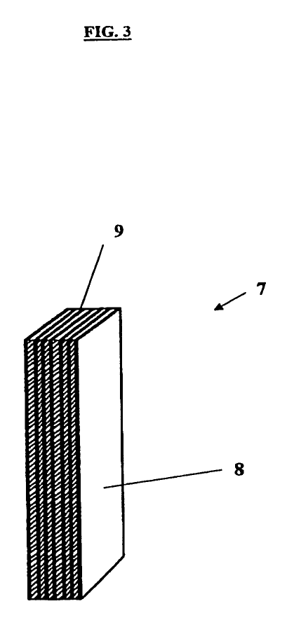

FIG. 3 illustrates one embodiment of the present invention where the resilient material (7) is in the form of strips of polyurethane (8) separated by thin bands of steel (9). These bands or shims of steel provide some strength to the resilient material (7) without sacrificing to any great degree its actual resilient properties.

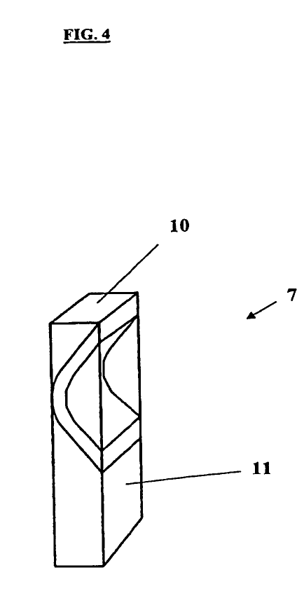

FIG. 4 illustrates an alternate embodiment wherein a leaf spring (10) is embedded into polyurethane (11) to provide an alternative form of resilient material (7).

It is envisaged that impact on top of the resilient material (7) will cause it to deform and upon release of the impact the spring (10) will assist the polyurethane (11) to retain its original form.

Aspects of the present invention have been described by way of example only and it should be appreciated that modifications and additions may be made thereto without departing from the scope of the appended claims.

What I/we claim is:

1. A method of assembling a rotor for use in a rock crusher characterised by the step of
a) positioning a resilient material between a rotor tip holder and the rotor.

2. A method as claimed in claim 1 wherein the resilient material includes polyurethane.

3. A method as claimed in claim 2 wherein the polyurethane has a Shore hardness of 95 on the C scale.

4. A method as claimed in any one of claims 1 to 3 wherein the resilient material is a combination of materials.

5. A method as claimed in claim 4 wherein the resilient material includes shims.

6. A method as claimed in claim 4 wherein the resilient material includes a spring.

7. A resilient material adapted for use in a rotor for a rock crusher.
the material characterised in that
the material is configured to fit between a rotor tip holder and the rotor.

8. A resilient material as claimed in claim 7 wherein the resilient material includes polyurethane.

9. A resilient material as claimed in claim 8 wherein the polyurethane has a Shore hardness of 95 on the C scale.

10. A resilient material as claimed in any one of claims 7 to 9 wherein the resilient material is a combination of materials.

11. A resilient material as claimed in claim 10 wherein the resilient material includes shims.

12. A resilient material as claimed in claim 10 wherein the resilient material includes a spring.

13. A rotor configured to include resilient material as claimed in any one of claims 7 to 12.

14. A rock crusher incorporating a rotor as claimed in claim 13.

15. A method substantially as herein described with reference to and as illustrated by the accompanying drawings.

16. A resilient material substantially as herein described with reference to and as illustrated by the accompanying drawings.

17. A rotor substantially as herein described with reference to and as illustrated by the accompanying drawings.

18. A rock crusher substantially as herein described with reference to and as illustrated by the accompanying drawings.
